(19) United States
(12) Patent Application Publication
(10) Pub. No.: US 2026/0022627 A1
(43) Pub. Date: Jan. 22, 2026

(54) ANOMALOUS WELL OPERATION DETECTION

(71) Applicant: Chevron U.S.A. Inc., San Ramon, CA (US)

(72) Inventors: Amine Zejli, Houston, TX (US); Benjamin Cormier, San Ramon, CA (US); Anurag Shrestha, Midland, TX (US)

(21) Appl. No.: 18/780,249

(22) Filed: Jul. 22, 2024

(51) Int. Cl. E21B 43/12; G06F 11/34

(52) U.S. Cl. CPC E21B 43/122; G06F 11/3452

(57) ABSTRACT

Events at a well over a duration of time are detected based on changes in the values of the operation characteristics of the well. The changes in values of operation characteristics are classified as being positive change, negative change, or no change, and the events at the well are detected based on combinations of positive change, negative change, and no change for different operation characteristics. Anomalies at the well are detected based on the events detected at the well over the duration of time.

### FIELD

The present disclosure relates generally to the field of detecting anomalous well operations.

### BACKGROUND

Well operations may need to be monitored to ensure efficient and production operation of wells. Detecting anomalous well operations may be difficult due to the dynamic nature of well operations and the large amounts of field measurements that need to be analyzed.

### SUMMARY

This disclosure relates to detecting anomalous well operations. Well operation information and/or other information may be obtained. The well operation information may define values of operation characteristics of a well as a function of time. Events at the well over a duration of time may be detected based on changes in the values of the operation characteristics of the well and/or other information. An anomaly at the well over the duration of time may be detected based on the events detected at the well over the duration of time and/or other information. Operation of the well may be facilitated based on the anomaly detected at the well and/or other information.

A system for detecting anomalous well operations may include one or more electronic storage, one or more processors and/or other components. The electronic storage may store information relating to a well, well operation information, information relating to operation characteristics of the well, information relating to events at the well, information relating to anomalies at the well, information relating to operation of the well, and/or other information.

The processor(s) may be configured by machine-readable instructions. Executing the machine-readable instructions may cause the processor(s) to facilitate detecting anomalous well operations. The machine-readable instructions may include one or more computer program components. The computer program components may include one or more of an operation characteristic component, an event component, an anomaly component, a well operation component, and/or other computer program components.

The operation characteristic component may be configured to obtain well operation information and/or other information. The well operation information may define values of operation characteristics of a well as a function of time. In some implementations, the well may include a gas lift well. In some implementations, the operation characteristics of the well may include bottom hole pressure, casing pressure, flowline pressure, tubing pressure, injection pressure, injection flowrate, and/or delta pressure.

The event component may be configured to detect events at the well over a duration of time. The events at the well over the duration of time may be detected based on changes in the values of the operation characteristics of the well and/or other information.

In some implementations, the events at the well may be detected based on comparison of the changes in the values of the operation characteristics of the well to standard deviations of the changes in the values of the operation characteristics of the well. A standard deviation of the changes in the values of a given operation characteristic of the well may be determined based on historical values of the given operation characteristic of the well and/or other information. A positive change threshold and a negative change threshold for the given operation characteristic of the well may be determined based on the standard deviation of the changes in the values of the given operation characteristic of the well and/or other information.

In some implementations, responsive to a given change in the values of the given operation characteristic including an increase greater than the positive change threshold, the given change in the values of the given operation characteristic may be classified as positive change. Responsive to the given change in the values of the given operation characteristic including a decrease greater than the negative change threshold, the given change in the values of the given operation characteristic may be classified as negative change. Responsive to the given change in the values of the given operation characteristic including an increase smaller than the positive change threshold or a decrease smaller than the negative change threshold, the given change in the values of the given operation characteristic may be classified as no change.

In some implementations, different event types may be associated with different combinations of positive change, negative change, and no change in the values of the operation characteristics of the well.

The anomaly component may be configured to detect one or more anomalies at the well over the duration of time. The anomal(ies) at the well over the duration of time may be detected based on the events detected at the well over the duration of time and/or other information.

In some implementations, numbers of the events at the well over the duration of time may be determined. The anomal(ies) at the well may be flagged based on the numbers of the events at the well over the duration of time.

In some implementations, a given type of the anomaly is associated with multiple event types. The anomaly of the given type may be flagged based on numbers of the events of the multiple event types that have been detected at the well over the duration of time.

In some implementations, responsive to detection of an anomaly of a given type, one or more conditions of the well may be determined.

The well operation component may be configured to facilitate operation of the well. The operation of the well may be facilitated based on the anomal(ies) detected at the well and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for detecting anomalous well operations.

FIG. 2 illustrates an example method for detecting anomalous well operations.

FIG. 3 illustrates an example flow diagram for controlling well operations based on anomalous well operation detection.

FIG. 4 illustrates example changes in values of operation characteristics of a well as a function of time.

FIG. 5A illustrates example changes in values of operation characteristics of a well.

FIG. 5B illustrates example changes in values of operation characteristics of a well, positive thresholds, and negative thresholds.

FIG. 5C illustrates example classifications of changes in values of operation characteristics of a well.

FIG. 6 illustrates an example table that defines events based on changes in values of operation characteristics of a well.

FIG. 7 illustrates an example anomaly classification matrix.

FIG. 8 illustrates an example condition classification matrix.

FIG. 9 illustrates an example anomaly classification matrix.

FIG. 10 illustrates an example flow diagram for using multiple anomaly classification matrices.

### DETAILED DESCRIPTION

The present disclosure relates to detecting anomalous well operations. Events at a well over a duration of time are detected based on changes in the values of the operation characteristics of the well. The changes in values of operation characteristics are classified as being positive change, negative change, or no change, and the events at the well are detected based on combinations of positive change, negative change, and no change for different operation characteristics. Anomalies at the well are detected based on the events detected at the well over the duration of time.

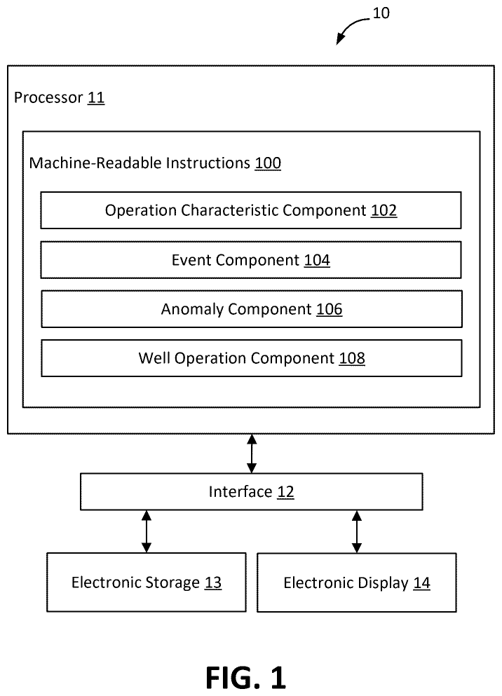

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Well operation information and/or other information may be obtained by the processor 11. The well operation information may define values of operation characteristics of a well as a function of time. Events at the well over a duration of time may be detected by the processor 11 based on changes in the values of the operation characteristics of the well and/or other information. An anomaly at the well over the duration of time may be detected by the processor 11 based on the events detected at the well over the duration of time and/or other information. Operation of the well may be facilitated by the processor 11 based on the anomaly detected at the well and/or other information.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store information relating to a well, well operation information, information relating to operation characteristics of the well, information relating to events at the well, information relating to anomalies at the well, information relating to operation of the well, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a well, well operation information, information relating to operation characteristics of the well, information relating to events at the well, information relating to anomalies at the well, information relating to operation of the well, and/or other information.

Managing a field of well is a difficult task, especially with increases in the number of wells and with a limited number of personnel/available time to review well operations. Identifying anomalous well operations and making operational changes to the wells may require analysis of large amounts of data from the wells. The dynamic nature of well operations and large amounts of field measurements may make analysis of well operations onerous.

The present disclosure provides an anomalous well operation detection tool for a field of wells. The tool simplifies detection of anomalous well operations using changes in well operation characteristics and enables classification of the anomalous well operations. The tool enables targeting of anomalous wells for remedial measures.

For example, the tool detects meaningful changes in real time well data and field measurement data to accurately identify changes in well performance or well integrity. The tool utilizes a multi-stage event detection and classification model to identify anomalous conditions at the wells. The tools enables efficient monitoring and management of numerous wells in a field.

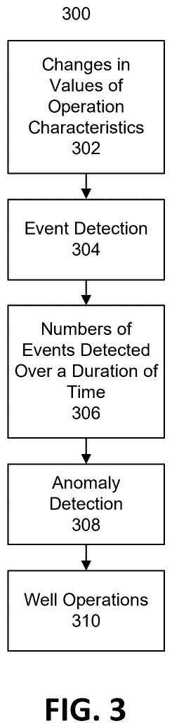

FIG. 3 illustrates an example flow diagram 300 for controlling well operations based on anomalous well operation detection. Changes in values of operation characteristics 302 of wells in a field may be obtained. The changes in the values of the operation characteristics 302 may be obtained over a duration of time (as time series data). Event detection 304 for the wells in the field may be performed using the changes in the values of the operation characteristics 302 of the wells in the field. The change in the values of the operation characteristics 302 over the duration of time may be used to detect events at the wells over the duration of time. Statistical methods may be used to normalize the values of well operation characteristics to define normal operating conditions and reduce the noise when detecting events at the wells. The numbers of events detected at the wells over the duration of time 306 may be determined (tracked). Anomaly detection 308 may be performed for the wells in the field using the numbers of events detected at the wells over the duration of time 306. Well operations 310 may be facilitated (e.g., controlled, determined, implemented) based on the anomal(ies) detected at the wells.

In some implementations, multiple anomalous well operation detections may be used in parallel. For example, the event detection 304 may be used to detect events based on sudden/fast and large changes in well operation characteristics, and the detected events may be used to detect anomalies at the well. Trend monitoring may be used to detect slow changes in well operation characteristics. Trend monitoring may be used to detect anomalies at the wells based on slow changes in the well operation characteristics over time. Physics-based modeling may be used to detect anomalies at the well based on characteristics of the wells.

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate detecting anomalous well operations. The machine-readable instructions 100 may include one or more computer program components. The machine-readable instructions 100 may include one or more of an operation characteristic component 102, an event component 104, an anomaly component 106, a well operation component 108, and/or other computer program components.

The operation characteristic component 102 may be configured to obtain well operation information and/or other information. Obtaining well operation information may include one or more of accessing, acquiring, analyzing, determining, developing, examining, generating, identifying, loading, locating, measuring, opening, preparing, receiving, retrieving, reviewing, selecting, storing, and/or otherwise obtaining the well operation information. Well operation information for a single well or multiple wells may be obtained. The operation characteristic component 102 may obtain well operation information from one or more locations. For example, the operation characteristic component 102 may obtain well operation information from a storage location, such as the electronic storage 13, electronic storage of a device accessible via a network, and/or other locations. The operation characteristic component 102 may obtain well operation information from one or more hardware components (e.g., a computing device, a sensor) and/or one or more software components (e.g., software running on a computing device).

The well operation information may define values of operation characteristics of one or more wells. A well may refer to a hole that is drilled in the ground. A well may be drilled in the ground for exploration and/or recovery of resources in the ground, such as water or hydrocarbons. For example, a well may be drilled for production of hydrocarbons (e.g., as a production well). The term “wellbore,” “well bore,” “borehole,” and the like may be utilized interchangeably with the term “well.” A well may be located in a reservoir.

A reservoir may refer to a location at which one or more resources are stored. For example, a reservoir may refer to a location at which hydrocarbons are stored. For instance, a reservoir may refer to a location including rocks in which oil and/or natural gas have accumulated. A reservoir may include one or more wells. For example, a reservoir may include one or more injection wells (e.g., for injection of fluid), one or more production wells (e.g., for extraction of oil or gas), and/or other wells. A reservoir may refer to a location in which buoyant forces keep hydrocarbons in place below a sealing caprock. A reservoir may refer to a location in which oil or natural gas do not readily flow into a well. A reservoir may refer to a location in which hydraulic fractures may be used to extract the stored resources, such as an unconventional reservoir (e.g., tight-sand, gas and/or oil shales). An unconventional reservoir may refer to a reservoir where hydrocarbons and/or other resources (e.g., oil, gas) are tightly bound to the rock fabric by strong capillary forces. Resources may be held by dense structure with lower permeability.

In some implementations, a well may include a gas lift well. A gas lift well may be located in an unconventional reservoir. Use of the present disclosure on other types of wells in conventional reservoirs or unconventional reservoirs is contemplated.

An operation characteristic of a well may refer to an attribute, quality, configuration, parameter, and/or characteristics of matter inside, within, and/or around the well during operation. An operation characteristic of a well may refer to characteristics of the well, characteristics of one or more components of the well, characteristics of conditions around the well, characteristics of conditions inside the well, and/or other characteristics of the during operation. An operation characteristic of a well may include a dynamic characteristic (e.g., properties of materials/fluids inside or around the well, operation parameters of the well) that changes with time/operation of the well. Operation characteristic of a well may be measured using one or more sensors. Examples of operation characteristics of a well may include bottom hole pressure, casing pressure, flowline pressure, tubing pressure, injection pressure, injection flowrate, and/or delta pressure. Other types of operation characteristics are contemplated.

The well operation information may define values of operation characteristics of well(s) as a function of time. The well operation information may define the values of the operation characteristics of well(s) at different moments in time. The well operation information may define values of operation characteristics of well(s) over one or more durations of time. The well operation information may include time-series data (e.g., time-series signal data) of the values of the operation characteristics of the well(s). In some implementations, the values of the operation characteristics of a well may be standardized using scaler.

The well operation information may define values of operation characteristics of a well by including information that characterizes, describes, delineates, identifies, is associated with, quantifies, reflects, sets forth, and/or otherwise defines the values of the operation characteristics of the well. The well operation information may directly and/or indirectly define values of operation characteristics of a well. For example, the well operation information may define values of operation characteristics of a well by including information that specifies the types and/or the values of the operation characteristics of the well and/or information that may be used to determine the types and/or values of the operation characteristics of the well. Other types of well operation information are contemplated.

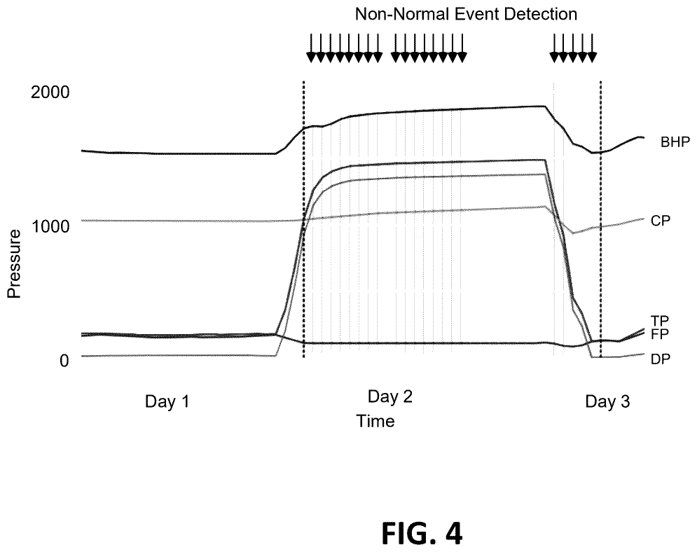

The values of the operation characteristics of a well may change over time. FIG. 4 illustrates example changes in values of operation characteristics of a well as a function of time. FIG. 4 shows changes in values of bottom hole pressure, tubing pressure, casing pressure, flowline pressure, and delta pressure of a well over a few days.

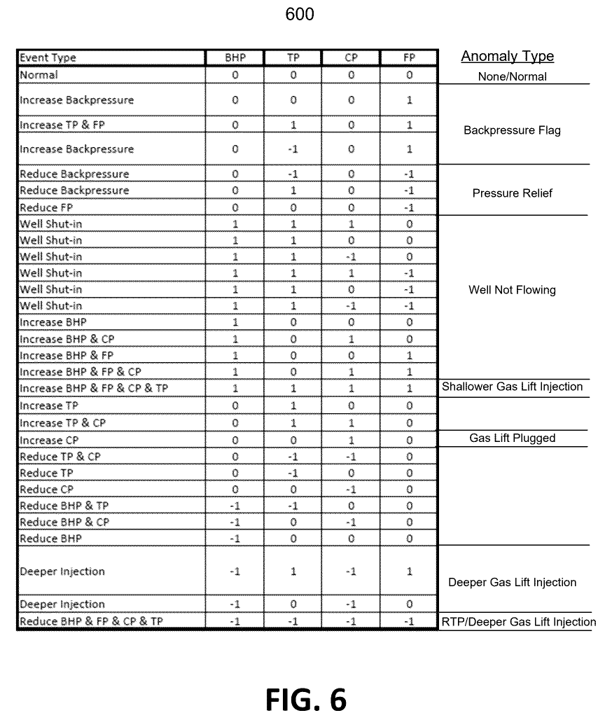

The event component 104 may be configured to detect events at the well(s) over a duration of time. Detecting an event at a well may include one or more of classifying, determining, finding, identifying, and/or otherwise detecting the event at the well. Detecting an event at a well may include determining a type of the event at the well. Detecting an event at a well may include determining when the event starts or ends at the well. An event at a well may refer to an outcome or a result of an operation of the well. An event at a well may change the values of the operation characteristics of the well. Example types of events at a well may include increase or decrease in a certain type of pressure (e.g., bottom hole pressure, tubing pressure, casing pressure, flowline pressure) at the well and/or a combination of increase and/or decrease in multiple types of pressure at the well. Example of event types are listed in FIG. 6. Other types of events are contemplated.

The events at a well over a duration of time may be detected based on changes in the values of the operation characteristics of the well and/or other information. Changes in the time-series signal data of the operation characteristic may be used to detect the events at the well. Changes in/deviation of the values of the operation characteristics from one or more baseline values (e.g., mean values) may be used to detect evets at the well. Sudden/fast and large changes in the values of the operation characteristics of the well may be used to detect events at the well. A sudden/fast and large change in the values of an operation characteristic may include more than a threshold amount of change over a set period of time. Rather than looking at exact amount of changes, sudden/fast and large changes in the values of the operation of characteristics may be used to identify events at the well, and the patterns of sudden/fast and large changes in the values of the operation of characteristics over a duration of time may be used to detect anomalies at the well.

The events at a well may be detected periodically over a duration of time. Rather than detecting events only when certain changes in operation characteristics are identified, events may be detected at a certain frequency over the duration of time. For example, an event at the well may be detected every ten minutes over a six hour period. Use of other frequency of event detection and other duration of time is contemplated.

In some implementations, events at a well may be detected based on comparison of the changes in the values of the operation characteristics of the well to standard deviations of the changes in the values of the operation characteristics of the well. A standard deviation of the changes in the values of an operation characteristic of a well may refer to a quantity that indicates the extent of deviation of the values from the mean value. A standard deviation of the changes in the values of an operation characteristic of the well may be determined based on historical values of the operation characteristic of the well and/or other information. For example, historically measured values of the operation characteristic over a period of time (e.g., 6-9 months, period of time to establish normal distribution of the values) may be used to determine the standard deviation for the operation characteristic.

Comparison of the changes in the values of an operation characteristic to a standard deviation may include comparison to the exact standard deviation value or to a scaled value of the standard deviation (e.g., a fraction of the standard deviation, a multiple of the standard deviation). For example, one or more thresholds may be determined based on the standard deviation of the operation characteristics and the changes in the values of the operation characteristics may be compared to the threshold(s). For instance, a positive change threshold and a negative change threshold for the operation characteristic of the well may be determined based on the standard deviation of the changes in the values of the operation characteristic of the well and/or other information. The value of the positive change threshold and the negative change threshold may be the same or different. For example, the positive change threshold may be set to a certain number of standard deviation above the mean and the negative change threshold may be set to a certain number of standard deviation below the mean to cover 0.05% of the top values and 0.05% of the bottom values (p-value of 0.1). The number of standard deviation to use may depend on the well, the reservoir, the operations being performed at the well, historical measurements from the well, and/or other information.

For example, the value of the positive change threshold and the negative change threshold may be determined based on a p-value that is tuned to a particular well. An initial p-value may be determined based on characteristics of the well (e.g., age of the well) and the type of operation characteristic (e.g., BHP, TP, CP, FP, DP). The use of the initial p-value to set the value of the positive change threshold and the negative change threshold may result in anomaly being detected over one or more durations of time over the period of well operation. The fraction of time over which anomaly is detected over the period of well operation may be referred to as anomaly percentage. The p-value may be increased or decreased to bring the anomaly percentage to a desired/target value. For example, the p-value (and resulting positive change threshold and negative change threshold) may be adjusted to obtain particular anomaly percentage (e.g., x % from positive change threshold and y % from negative change threshold). In some implementations, the p-value may be increased (reducing the anomaly percentage) but not decreased. For example, if the anomaly percentage (from positive change threshold or negative change threshold) is too high (higher than the desired/target value), the anomaly percentage may be decreased by increasing the p-value (e.g., a certain percentage at a time) until the anomaly percentage is equal to the desired/target value. The p-value (and resulting positive change threshold and negative change threshold) may be re-tuned periodically (e.g., every 12 hours using the latest 6-months of data). The p-value, the positive change threshold, and the negative change threshold may be adjusted based on well data to meet a certain statistical distribution (e.g., x % from positive change threshold and y % from negative change threshold).

The changes in the values of an operation characteristic may be classified as positive change, negative change, or no change based on comparison to the standard deviation/threshold. For example, responsive to a change in the values of an operation characteristic (over a time step/duration) including an increase greater than the positive change threshold, the change in the values of the operation characteristic may be classified as positive change. Responsive to a change in the values of an operation characteristic including a decrease greater than the negative change threshold, the change in the values of the operation characteristic may be classified as negative change. Responsive to the change in the values of an operation characteristic including an increase smaller than the positive change threshold or a decrease smaller than the negative change threshold, the change in the values of the given operation characteristic may be classified as no change.

Once an operation characteristic is classified with positive change or negative change, the operation characteristic may continue to be classified with the same change (positive change, negative change) until the operation characteristic returns to normal values. For example, if a change in the values of the operation characteristic at a moment in time is greater than the positive change threshold (changes from a value within a normal range to a high value), the change at the moment may be classified as positive change. If the following values of the operation characteristic remain high (outside the normal range, beyond positive/negative change threshold), the following values of the operation characteristic may be classified as positive change. When the values of the operation characteristic fall back down to normal values (e.g., within 95% confidence interval of the mean value with a P-value of 0.05, within the 95% confidence interval determined using historical values of the operation characteristic of the well over a period of time, such as 6-9 months), the values of the operation characteristic may be classified as no change.

Events at a well at a moment in time may be detected based on the combination (pattern) of positive change, negative change, and/or no change in the values of the operation characteristics of the well at the moment in time. The combination of positive change, negative change, and/or no change in the values of the operation characteristics of the well at a moment in time may be used as a fingerprint to identify the event/event type at the well. For example, in FIG. 4, the changes in the values of bottom hole pressure, tubing pressure, casing pressure, flowline pressure, and delta pressure may be classified as positive change, negative change, or no change, and the combinations of change classification at different moments in time may be used to identify events at the different moments in time. FIG. 4 may show non-normal events (e.g., pressure relief, well not flowing) detected using arrows.

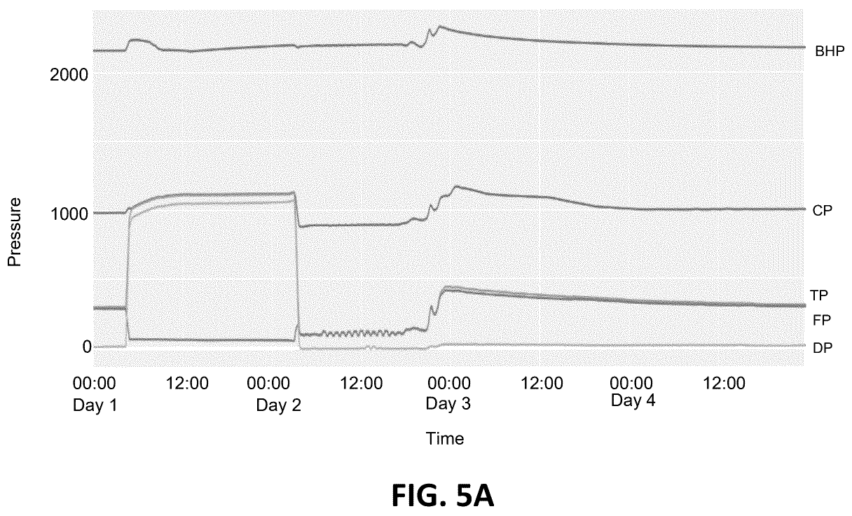

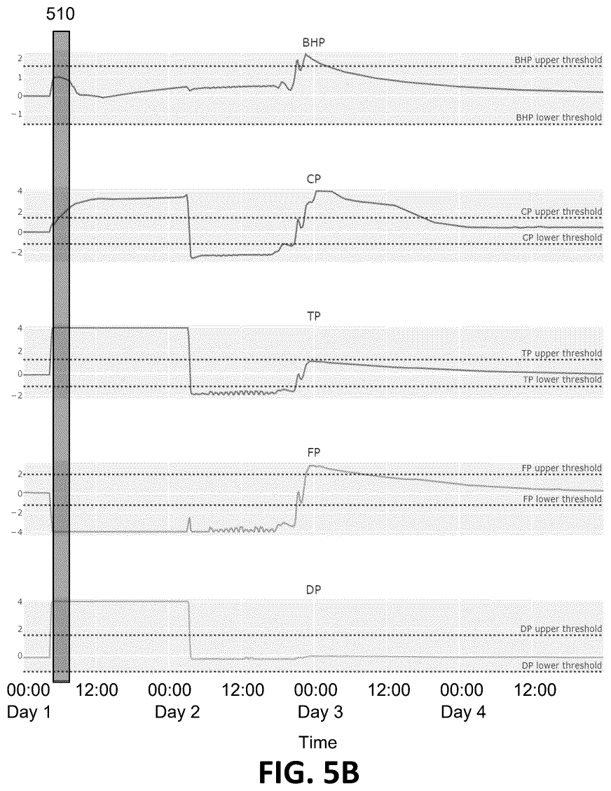

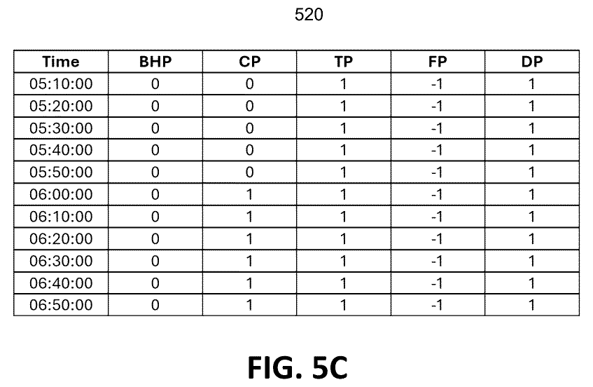

FIG. 5A illustrates example changes in values of operation characteristics of a well. FIG. 5A shows changes in values of bottom hole pressure, tubing pressure, casing pressure, flowline pressure, and delta pressure of a well over a few days. The values of operation characteristics of the well may be normalized, such as shown in FIG. 5B. FIG. 5B shows separate positive thresholds (upper thresholds) and negative thresholds (lower thresholds) for separate operation characteristics. Based on comparison of the changes in the values of the operation characteristics (bottom hole pressure, casing pressure, tubing pressure, flowline pressure, delta pressure) to positive and negative thresholds (upper and lower thresholds), the changes may be classified as being positive change (when the increase is greater than the positive threshold), negative change (when the decrease is greater than the negative threshold), or no change (when the increase or decrease if between the positive and negative thresholds). FIG. 5C illustrates example classifications of changes in values of operation characteristics of a well. A table 520 may show positive change indicated with the value “1,” negative change indicated with the value “−1,” and no change indicated with the value “0.” The table 520 may show classification of operation characteristic values over a time period marked by a box 510 in FIG. 5B. Once an operation characteristic is marked with “1” or “−1,” the operation characteristic may continue to be marked with “1” or “−1” until the value of the operation characteristic returns to normal.

In some implementations, different event types may be associated with different combinations of positive change, negative change, and no change in the values of the operation characteristics of the well. One type of event may be associated with one combination of positive change, negative change, and no change in the values of the operation characteristics of the well and another type of event may be associated with another combination of positive change, negative change, and no change in the values of the operation characteristics of the well.

FIG. 6 illustrates an example table 600 (trend analysis matrix) that defines events based on changes in values of operation characteristics of a well. For example, a normal event type may be associated with no change in bottom hole pressure, tubing pressure, casing pressure, and flowline pressure. A reduce flowline pressure event may be associated with no change in bottom hole pressure, tubing pressure, and casing pressure and negative change in flowline pressure. An event type may be associated with one or more combinations of positive change, negative change, and no change in the values of the operation characteristics of the well. For example, well shut-in event type may be associated with six different combination of positive change, negative change, and no change in the values of bottom hole pressure, tubing pressure, casing pressure, and flowline pressure. Use of other operation characteristics and other associations between event types of combinations of positive change, negative change, and no change of operation characteristics are contemplated.

The anomaly component 106 may be configured to detect one or more anomalies at the well(s) over the duration of time. Detecting an anomaly at a well may include one or more of classifying, determining, finding, identifying, and/or otherwise detecting the anomaly at the well. Detecting an anomaly at a well may include determining a type of the anomaly at the well. Detecting an anomaly at a well may include determining when the anomaly starts or ends at the well. An anomaly at a well may refer to an outcome or a result of an operation of the well that differs from what is normal, expected, or typical. An anomaly at a well may refer to a problematic condition or operation of the well. An anomaly at a well may degrade the efficiency of well operation. Example types of anomalies at a well may include backpressure flag, pressure relief (if not expected), well not flowing, shallower gas lift injection, deeper gas lift injection (if not expected), gas lift plugged. Other types of anomalies are contemplated. Upon anomaly detection, operation of the well may be changed to return the well to production (RTP).

The anomal(ies) at a well over the duration of time may be detected (flagged) based on the events detected at the well over the duration of time and/or other information. The anomal(ies) at a well over the duration of time may be detected based on sequence of events detected at the well over the duration of time and/or other information. What and how many events are detected at a well over the duration of time may be used to detect anomal(ies) at the well.

For example, numbers of events at the well that have been detected over the duration of time may be determined. Numbers of different event types that have been detected at the well over the duration of time may be counted/tracked. The anomal(ies) at the well may be flagged based on the numbers of events at the well over the duration of time. Different event types may be associated with different anomalies. An anomaly may be flagged based on the event type(s) associated with the anomaly having been detected over the duration of time more than event type(s) associated with other anomalies. The anomaly associated with the highest number of event(s) over the duration of time may be flagged. Use of the number of event detection over the duration of time to flag anomalies may be fast and efficient. Use of the number of event detection over the duration of time to flag anomalies may tune out noise in the operation characteristics of the well.

A given type of anomaly may be associated with a single event type or multiple event types. FIG. 6 show example association between different event types and different anomaly types. For example, no anomaly may be associated with normal event type. Backpressure flag anomaly type may be associated with increase backpressure event type, increase tubing pressure & flowline pressure event type, and increase backpressure event type. Anomaly type with the highest number of associated event type detected over a duration of time may be determined as the anomaly at the well. For example, whether no anomaly has occurred or backpressure flag anomaly has occurred over the duration of time may be determined by counting the number of times normal event type, increase backpressure event type, increase tubing pressure & flowline pressure event type, and increase backpressure event type have been detected over the duration of time. If the number of normal event type detection is greater than the total number of increase backpressure event type, increase tubing pressure & flowline pressure event type, and increase backpressure event type detection, then no anomaly may be detected at the well. If the total number of increase backpressure event type, increase tubing pressure & flowline pressure event type, and increase backpressure event type detection is greater than the number of normal event type detection, then backpressure flag anomaly may be detected at the well.

In some implementations, one or more conditions at a well may be determined. For example, responsive to detection of a particular anomaly at the well, condition(s) at the well may be determined using operation characteristic(s) of the well. For example, if well not flowing anomaly type is detected, the condition at the well may be determined as hole in tubing (based on tubing pressure being equal to casing pressure), U-tubing gas (based on gas lift being greater than zero and tubing pressure being equal to or less than flowline pressure), or gas lift valve failure (based on casing head pressure and tubing pressure returning to previous normal values after shut-in but shows sign of hole-in tubing during shut-in). If RTP/deeper gas lift injection anomaly type is detected, the condition at the well may be determined as returning to production (based on RTP/deeper gas lift injection detection after detection of well not flowing anomaly) or deeper gas lift injection (based on RTP/deeper gas lift injection detection when no anomalies are detected).

In some implementations, anomal(ies) at the well(s) may be detected directly from the operation characteristics of the well. For example, in parallel to the use of event detection to detect anomalies at a well, trend monitoring of operation characteristics may be used to detect anomalies at the well. Event-to-anomaly detection and trend monitoring anomaly detection may cover different durations of time. For example, event-to-anomaly detection may utilize shorter duration of time than trend monitoring anomaly detection (e.g., use of six hours of data for event-to-anomaly detection and use of twelve hours of data for trend monitoring anomaly detection). Event-to-anomaly detection may be used to detect anomalies that occur over a shorter duration of time while trend monitoring anomaly detection may be used to detect anomalies that occur over a longer duration of time. For example, hole in tubing anomaly may be detected based on casing pressure continually declining over time and being less than a threshold value (e.g., 600 psi) during well operation. Gas lift multipointing anomaly may be detected based on casing pressure, tubing pressure, and flowline pressure fluctuating frequently (e.g., more rapidly than a threshold frequency) on a gas lift well. Well not flowing anomaly may be detected based on flowline pressure being equal to or greater than tubing pressure. Inflow issue (slugging) anomaly may be detected based on casing and gas lift injection being stable (not fluctuating more than a threshold amount) but the flowline pressure, tubing pressure, and bottom hole pressure fluctuating (changing more than a threshold amount). Inflow issue (plugged) anomaly may be detected based on bottom hole pressure dropping by less than a threshold amount (e.g., 400 psi) later in the life of the well. Bottle necking anomaly may be detected based on tubing pressure being greater than flowline pressure by more than a threshold amount (e.g., 50 psi). Frac hit anomaly may be detected based on bottom hole pressure increasing by more than a threshold amount in a duration of time (e.g., more than 150 psi in 24 hours, more than 7% in 24 hours). Other anomaly detection using trend monitoring is contemplated.

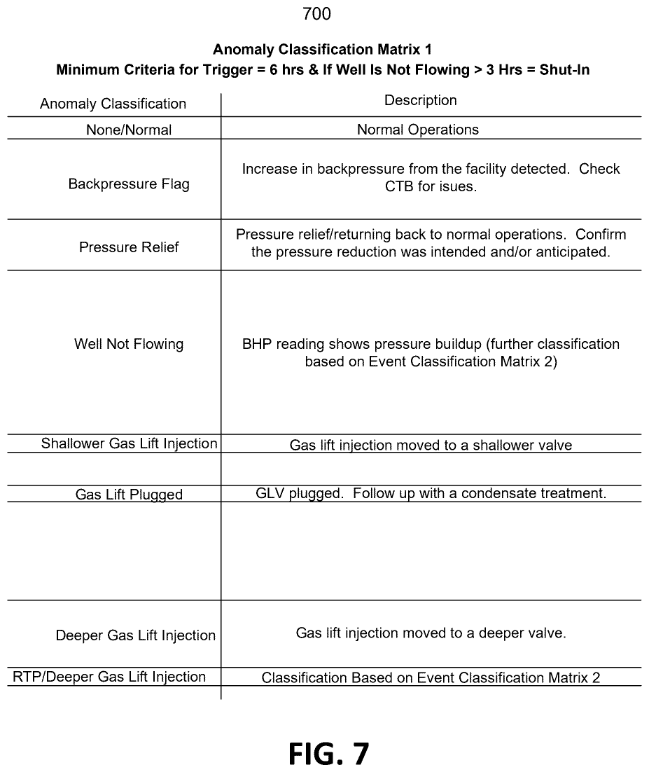

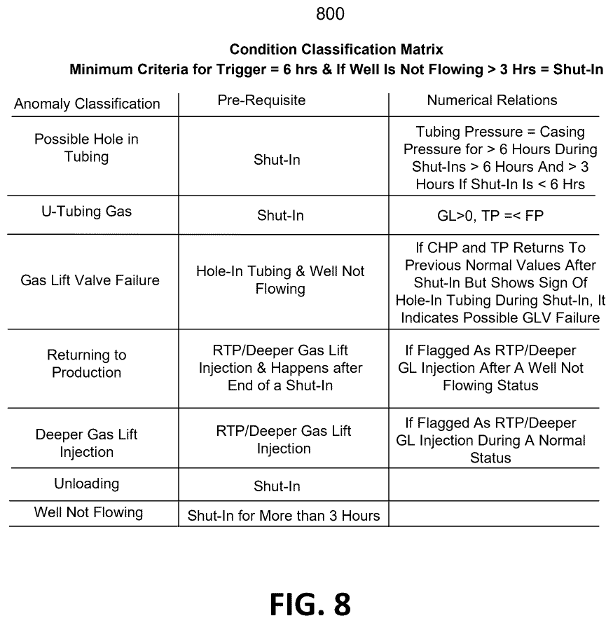

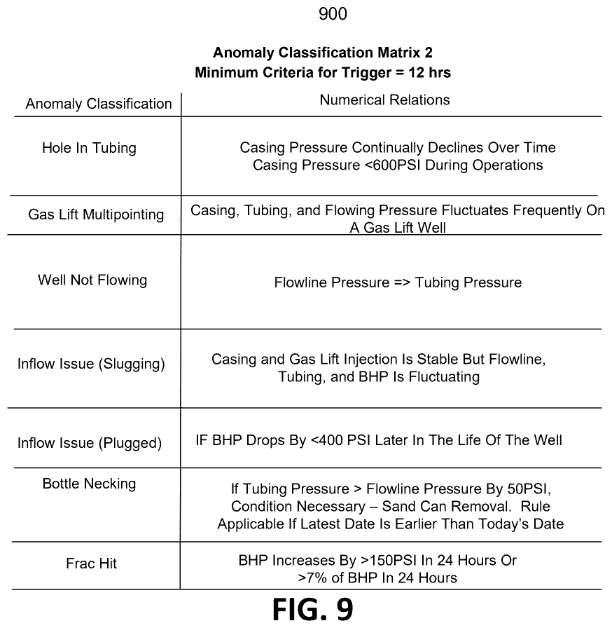

FIG. 7 illustrates an example anomaly classification matrix 700 (anomaly classification matrix 1). The anomaly classification matrix 700 may show classification of anomalies from events detected via a trend analysis matrix, such as shown in FIG. 6. FIG. 8 illustrates an example condition classification matrix 800. The condition classification matrix 800 may show determination of well conditions using one or more rules (pre-requisite, numerical relations) based on detection of particular anomalies. FIG. 9 illustrates an example anomaly classification matrix 900 (anomaly classification matrix 2). The anomaly classification matrix 900 may show classification of anomalies directly from operation characteristics of a well.

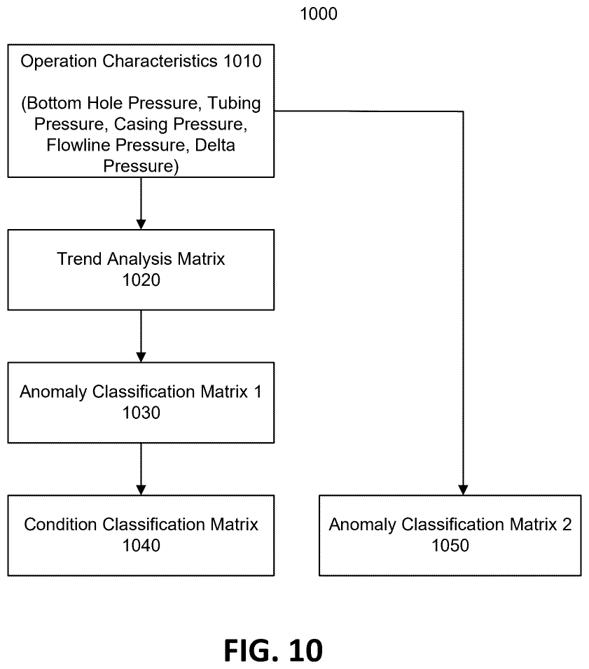

FIG. 10 illustrates an example flow diagram 1000 for using multiple anomaly classification matrices. Operation characteristics 1010 of a well (e.g., bottom hole pressure, tubing pressure, casing pressure, flowline pressure, delta pressure) may be used to detect anomalies at the well. The flow diagram 1000 may include two parallel paths for anomaly detection. In one path, the operation characteristics 1010 (changes in values of the operation characteristics 1010) may be used to detect events at the well via a trend analysis matrix 1020, such as shown in FIG. 6. Events detected via the trend analysis matrix 1020 may be used to detect anomalies via an anomaly classification matrix 1 1030, such as shown in FIG. 7. One or more conditions at the well may be determined via a condition classification matrix 1040, such as shown in FIG. 8. In the other path, the operation characteristics 1010 may be used to directly detect anomalies via an anomaly classification matrix 2 1050, such as shown in FIG. 9. Use of other matrices and rules are contemplated.

The well operation component 108 may be configured to facilitate operation of the well(s). Operation of a well may refer to an operation relating to the well, performance of work on and/or use of the well, an activity involving the well, and/or other operation of the well. Facilitating operation of a well may include assisting, automating, carrying out, controlling, designing, enabling, implementing, initiating, performing, planning, scheduling, setting up, and/or otherwise facilitating the operation of the well. Facilitating operation of a well may include starting, stopping, changing, preventing, and/or otherwise controlling the operation of the well. Facilitating operation of a well may include providing information about the operation of the well to one or more personnels (e.g., engineers, field operators). For example, information on well identifiers, well types, anomaly types, anomaly duration/count, anomaly trend, underlying events, and/or other information relating to operation of the well may be presented. Facilitating operation of a well may include recommending one or more operations for the well to one or more personnels. Facilitating operation of a well may include automating one or more operations for the well (e.g., operations to address/fix the anomaly). Anomaly detection and well operation may be integrated into a nodal analysis for multiple wells in a field to manage and increase efficiency of (e.g., optimize production from) the wells in the fields. Other facilitations of operation of well(s) are contemplated.

The operation of a well may be facilitated based on the anomal(ies) detected at the well and/or other information. The operation of a well may be facilitated based on the types of anomal(ies) detected at the well and/or other information. Different operations may be facilitated based on different anomalies detected at a well. Different alarms and/or flags may be generated for different anomalies detected at a well. For example, different operations may be designed, changed, implemented, and/or otherwise performed based on different anomalies detected at a well. For instance, responsive to detection of backpressure flag anomaly (indicating increase in backpressure from facility), central tank battery may be checked for issues. Responsive to detection of pressure relief anomaly (indicating a well returning to normal operations), pressure reduction may be checked to confirm that it was intended and/or anticipated. Responsive to detection of gas lift plugged anomaly (indicating that gas lift value is plugged), a condensate treatment may be performed remove material plugging the gas lift valve. Other operations are contemplated.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

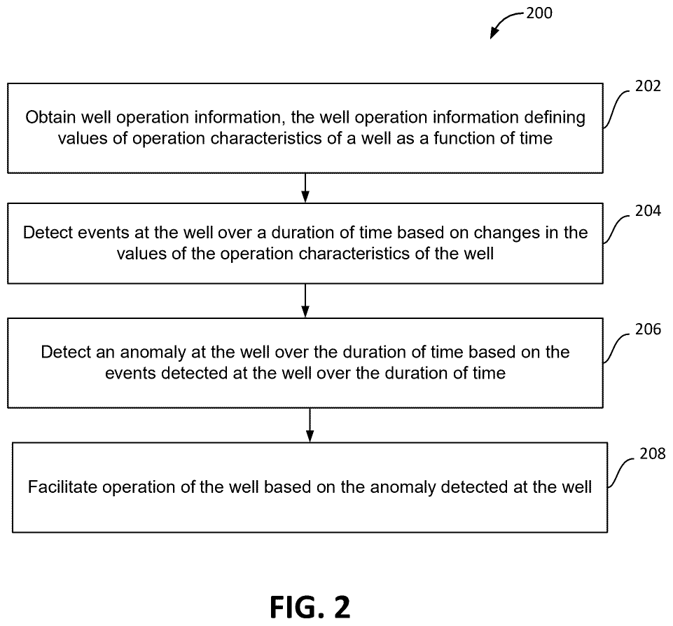

FIG. 2 illustrates a method 200 for detecting anomalous well operations. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, well operation information may be obtained. The well operation information may define values of operation characteristics of a well as a function of time. In some implementations, operation 202 may be performed by a processor component the same as or similar to the operation characteristic component 102 (Shown in FIG. 1 and described herein).

At operation 204, events at the well over a duration of time may be detected based on changes in the values of the operation characteristics of the well. In some implementations, operation 204 may be performed by a processor component the same as or similar to the event component 104 (Shown in FIG. 1 and described herein).

At operation 206, an anomaly at the well over the duration of time may be detected based on the events detected at the well over the duration of time. In some implementations, operation 206 may be performed by a processor component the same as or similar to the anomaly component 106 (Shown in FIG. 1 and described herein).

At operation 208, operation of the well may be facilitated based on the anomaly detected at the well. In some implementations, operation 208 may be performed by a processor component the same as or similar to the well operation component 108 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for detecting anomalous well operations, the system comprising:
one or more physical processors configured by machine-readable instructions to:
obtain well operation information, the well operation information defining values of operation characteristics of a well as a function of time;
detect events at the well over a duration of time based on changes in the values of the operation characteristics of the well;
detect an anomaly at the well over the duration of time based on the events detected at the well over the duration of time; and
facilitate operation of the well based on the anomaly detected at the well.

2. The system of claim 1, wherein the events at the well are detected based on comparison of the changes in the values of the operation characteristics of the well to standard deviations of the changes in the values of the operation characteristics of the well.

3. The system of claim 2, wherein:
a standard deviation of the changes in the values of a given operation characteristic of the well is determined based on historical values of the given operation characteristic of the well; and
a positive change threshold and a negative change threshold for the given operation characteristic of the well are determined based on the standard deviation of the changes in the values of the given operation characteristic of the well.

4. The system of claim 3, wherein:
responsive to a given change in the values of the given operation characteristic including an increase greater than the positive change threshold, the given change in the values of the given operation characteristic is classified as positive change;
responsive to the given change in the values of the given operation characteristic including a decrease greater than the negative change threshold, the given change in the values of the given operation characteristic is classified as negative change; and
responsive to the given change in the values of the given operation characteristic including an increase smaller than the positive change threshold or a decrease smaller than the negative change threshold, the given change in the values of the given operation characteristic is classified as no change.

5. The system of claim 1, wherein different event types are associated with different combinations of positive change, negative change, and no change in the values of the operation characteristics of the well.

6. The system of claim 1, wherein:
numbers of the events at the well over the duration of time are determined; and
the anomaly at the well is flagged based on the numbers of the events at the well over the duration of time.

7. The system of claim 6, wherein:
a given type of the anomaly is associated with multiple event types; and
the anomaly of the given type is flagged based on numbers of the events of the multiple event types that have been detected at the well over the duration of time.

8. The system of claim 1, wherein responsive to detection of the anomaly of the given type, a condition of the well is determined.

9. The system of claim 1, wherein the operation characteristics of the well include bottom hole pressure, casing pressure, flowline pressure, tubing pressure, injection pressure, injection flowrate, and/or delta pressure.

10. The system of claim 1, wherein the well includes a gas lift well.

11. A method for detecting anomalous well operations, the method comprising:
obtaining well operation information, the well operation information defining values of operation characteristics of a well as a function of time;
detecting events at the well over a duration of time based on changes in the values of the operation characteristics of the well;
detecting an anomaly at the well over the duration of time based on the events detected at the well over the duration of time; and
facilitating operation of the well based on the anomaly detected at the well.

12. The method of claim 11, wherein the events at the well are detected based on comparison of the changes in the values of the operation characteristics of the well to standard deviations of the changes in the values of the operation characteristics of the well.

13. The method of claim 12, wherein:
a standard deviation of the changes in the values of a given operation characteristic of the well is determined based on historical values of the given operation characteristic of the well; and
a positive change threshold and a negative change threshold for the given operation characteristic of the well are determined based on the standard deviation of the changes in the values of the given operation characteristic of the well.

14. The method of claim 13, wherein:
responsive to a given change in the values of the given operation characteristic including an increase greater than the positive change threshold, the given change in the values of the given operation characteristic is classified as positive change;
responsive to the given change in the values of the given operation characteristic including a decrease greater than the negative change threshold, the given change in the values of the given operation characteristic is classified as negative change; and
responsive to the given change in the values of the given operation characteristic including an increase smaller than the positive change threshold or a decrease smaller than the negative change threshold, the given change in the values of the given operation characteristic is classified as no change.

15. The method of claim 11, wherein different event types are associated with different combinations of positive change, negative change, and no change in the values of the operation characteristics of the well.

16. The method of claim 11, wherein:
numbers of the events at the well over the duration of time are determined; and
the anomaly at the well is flagged based on the numbers of the events at the well over the duration of time.

17. The method of claim 16, wherein:
a given type of the anomaly is associated with multiple event types; and
the anomaly of the given type is flagged based on numbers of the events of the multiple event types that have been detected at the well over the duration of time.

18. The method of claim 11, wherein responsive to detection of the anomaly of the given type, a condition of the well is determined.

19. The method of claim 11, wherein the operation characteristics of the well include bottom hole pressure, casing pressure, flowline pressure, tubing pressure, injection pressure, injection flowrate, and/or delta pressure.

20. The method of claim 11, wherein the well includes a gas lift well.
